(19) United States
(12) Patent Application Publication
(10) Pub. No.: US 2008/0063860 A1
(43) Pub. Date: Mar. 13, 2008

(54) CARBON NANOTUBE COMPOSITE

(75) Inventors: PENG-CHENG SONG, Beijing (CN); QIU-CEN ZHANG, Beijing (CN); CHANG-HONG LIU, Beijing (CN); SHOU-SHAN FAN, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/831,904

(22) Filed: Jul. 31, 2007

(30) Foreign Application Priority Data
Sep. 8, 2006 (CN) 200610062510.7

(51) Int. Cl. B32B 9/00

(52) U.S. Cl. 428/336; 428/408

(57) ABSTRACT

A carbon nanotube/polymer composite is described. The carbon nanotube/polymer composite includes at least one polymer material layer and at least one carbon nanotube/polymer composite layer. The carbon nanotube/polymer layer includes a polymer material and a plurality of carbon nanotubes embedded in the polymer material, wherein the carbon nanotube/polymer layer includes a top surface and a bottom surface opposite to the top surface, at least one of the top surface and bottom surface contacts with the adjacent polymer material layer, and the carbon nanotubes respectively contact at least one respective adjacent carbon nanotube to thereby yield a network of contacting carbon nanotubes.

### RELATED APPLICATIONS

This application is related to a commonly-assigned, co-pending application: U.S. patent application Ser. No. ______, entitled “METHOD OF PREPARING CARBON NANOTUBE/POLYMER COMPOSITE MATERIAL”, filed **** (Atty. Docket No. US11270). The disclosure of the above-identified application is incorporated herein by reference.

### BACKGROUND

1. Field of the Invention

The invention relates to polymer-based composites and, particularly, to a carbon nanotube/polymer composite.

2. Discussion of Related Art

Carbon nanotubes (also herein referred to as CNTs) were first observed and reported in an article by Iijima in 1991 (Nature, Vol. 354, Nov. 7, 1991, pp. 56-58). CNTs are tube-shaped structures composed of graphite. CNTs have a high Young's modulus, high thermal conductivity, and high electrical conductivity. Due to these and the other properties, it has been suggested that CNTs can play an important role in fields such as microelectronics, material science, biology, and chemistry.

CNTs together with polymer materials can be used to form CNTs/polymer composites. The CNTs/polymer composites have a high strength enhancement, a high flexibility, and the CNTs/polymer composites are of great interest to technology applications.

However, CNTs display the best thermal and electrical conductivity along long axis thereof. In the CNTs/polymer composites, CNTs are usually embedded in the polymer material matrix randomly and nonuniformly. Therefore, CNTs typically do not contact with adjacent CNTs sufficiently to facilitate useful levels of conductivity therebetween. Thus, each CNT of the CNTs/polymer composites cannot provide a direct, shortest-distance thermal conduction path and/or electrical transmission path from one end/side to the other end/side of the composite.

Therefore, a CNTs/polymer composite, with good thermal/electrical conductivity, is desired.

### SUMMARY

In one embodiment, a carbon nanotube/polymer composite is provided. The carbon nanotube/polymer composite includes at least one polymer material layer and at least one carbon nanotube/polymer composite layer. The carbon nanotube/polymer layer includes a polymer material and a plurality of carbon nanotubes (CNTs) embedded in the polymer material. The carbon nanotube/polymer layer includes a top surface and a bottom surface opposite to the top surface. At least one of the top surface and bottom surface contacts the adjacent polymer material layer, and adjacent carbon nanotubes contact each other.

Other advantages and novel features of the present composite will become more apparent from the following detailed description of preferred embodiments when taken in conjunction with the accompanying drawings.

### BRIEF DESCRIPTION OF THE DRAWINGS

Many aspects of the present carbon nanotube/polymer composite can be better understood with reference to the following drawings. The components in the drawings are not necessarily to scale, the emphasis instead being placed upon clearly illustrating the principles of the present composite.

FIG. 1 is a schematic, section view of a CNT/polymer composite, according to a present embodiment;

FIG. 2 is a SEM (scanning electron microscope) image of a CNT/polymer composite, in general accordance with the embodiment set forth in FIG. 1;

FIG. 3 is a graph of a current-voltage, measured parallel to the bottom surface of the CNT/polymer composite, according to a present embodiment, at a temperature of 77 K;

FIG. 4 is a graph of a current-voltage, measured parallel to the bottom surface of the CNT/polymer composite, according to a present embodiment, at a temperature of 297 K;

FIG. 5 is a graph of a current-voltage, measured parallel to the bottom surface of the CNT/polymer composite, according to a present embodiment, at a temperature of 420 K; and

FIG. 6 is a section view of a multi-layer CNT/polymer composite, according to another present embodiment.

Corresponding reference characters indicate corresponding parts throughout the several views. The exemplifications set out herein illustrate at least one preferred embodiment of the present composite, in one form, and such exemplifications are not to be construed as limiting the scope of the invention in any manner.

### DETAILED DESCRIPTION OF PREFERRED EMBODIMENTS

Reference will now be made to the drawings to describe embodiments of the present composite, in detail.

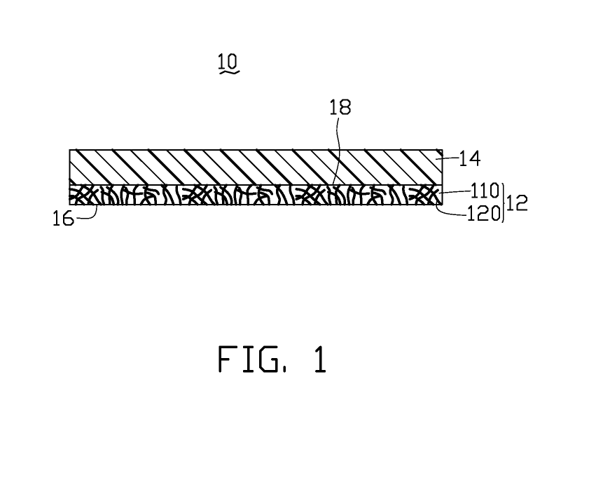

Referring to FIG. 1, a CNT/polymer composite 10 according to a preferred embodiment is a film structure. The CNT/polymer composite 10 includes a CNT/polymer layer 12 (hereinto also referred simply to as the CNT/polymer layer 12, to avoid confusion with the overall CNT/polymer composite 10) and a polymer material layer 14. The CNT/polymer layer 12 includes a polymer material 110 and a number of CNTs 120 embedded therein. The CNT/polymer layer 12 includes a top surface 18 and a bottom surface 16 opposite thereto. The polymer material layer 14 attaches directly (e.g., via polymer/polymer bond) to the top surface 18 of the CNT/polymer layer 12.

The polymer material 110 of the CNT/polymer layer 12 and the polymer material of the polymer material layer 14 are, advantageously, selected from the group consisting of polymethyl methacrylate, polyethyl acrylate, polybutyl acrylate, polystyrene, polybutadiene, polyacrylonitrile, and selectable mixtures thereof.

CNTs 120 may be single-wall carbon nanotubes and/or multi-wall carbon nanotubes, and a length of the CNTs 120 is, advantageously, 1 μm to 1000 μm. CNTs 120 are uniformly yet disorderly dispersed in the CNT/polymer layer 12. Because of this uniform but disordered dispersion, each CNT 120 is essentially assured of contacting (e.g., at least partially contact required; full-length contact not necessarily implied) with one or more adjacent CNTs. Thus, due to such a network of contacting CNTs, a number of thermally and/or electrically conductive paths are formed in the lateral direction parallel to the bottom surface 16. As such, the CNT/polymer composite 10 is thermally and/or electrically conductive along the lateral direction. Furthermore, in order to facilitate a connection with other electronic components, advantageously, end portions of the CNTs 120 extend out of the bottom surface 16.

A thickness of the polymer material layer 14 and a thickness of the CNT/polymer layer 12 are determined according to the application requirements. In the present embodiment, the total thickness of the CNT/polymer composite 10 is, beneficially, about in the range of 0.02 millimeters (mm) to 2 mm, and the thickness of the CNT/polymer layer 12 is, beneficially, about 1 micron (μm) to about 100 μm.

A method for manufacturing the CNT/polymer composite 10 is also provided. The method is described below, in detail.

In step 1, a CNT film is formed, for example, by a chemical vapor deposition method or by removing dimethylformamide from a solution of CNTs and dimethylformamide.

In step 2, a prepolymer solution is provided. In the present embodiment, the prepolymer is pre-polymethyl methacrylate. The method for preparing the pre-polymethyl methacrylate solution includes the following sub-steps of:

(a) mixing methyl methacrylates (MMA), aodiisobutyronitrile (AIBN) and α-dibutyl phthalate (DBP) and achieving a mixture; (b) stirring and heating and the mixture for polymerizing until the mixture is in a propanetriol form; and (c) curing the mixture until the polymerization action stops.

In sub-step (a), MMA is used as a main body, AIBN as an initiator, and DBP as an assistant. In the mixture, a mass percent of MMA is, about, 93 wt % to 99.98 wt %, a mass percent of AIBN is, approximately, 0.02 wt % to 2 wt %, and a mass percent of DBP is in the approximate range of 0 wt % to 5 wt %.

The main body also can be a material selected from the group consisting of ethylacrylate, butylacrylate, styrene, butadiene, acrylonitrile, and mixtures thereof. The initiator also can be benzoylperoxide. The assistant also can be a material selected from the group consisting of hexadecyl trimethyl ammonium bromide, polyethylene salt, polymethyl methacrylate salt, C12-C18 fatty acid, silicone coupler, titanate coupler, aluminiate coupler, and mixtures of such materials.

In sub-step (b), according to the present embodiment, the heating temperature is about from 80° C. to 95° C., and the time of stirring is from 5 minutes to 30 minutes.

In sub-step (c), in the present embodiment, the mixture is cured in air at room temperature, and a pre-polymethyl methacrylate solution is achieved.

In step 3, the CNT film is placed into a vessel and the pre-polymer solution is injected into the vessel.

The clearances/spaces among CNTs in the CNT film are filled with the pre-polymer solution. Furthermore, for filling the clearances completely, the vessel is stewed for a while, beneficially, for 0.5 hours to 2 hours.

In step 4, the pre-polymer is composited and transformed into a polymer material, and, thus, CNTs in the CNT film are bounded tightly within the polymer material, and then a CNT/polymer composite is formed. The thickness of the CNT/polymer composite is larger than that of the CNT film. Thus, the CNT/polymer composite includes two layers, i.e., the CNT film and the polymer material together form a CNT/polymer layer; and the polymer material higher/above than the CNT film (i.e., the now CNT/polymer layer) forms a polymer material layer. Essentially, a controlled excess amount of polymer material is applied, and, as such, the excess amount, free of any CNTs, constitutes (i.e., co-forms) a given polymer layer 14. The compositing step can be performed as follows: firstly, heating the pre-polymer solution together with the CNT film at 50-60° C. for 1-4 hours; then, heating the pre-polymer solution together with the CNT film at 90-100° C. for about 2 hours; and finally, achieving the CNT/polymer composite. In particular, the pre-polymer solution that intersperses with the CNT film contributes to the formation of a given CNT/polymer layer, while the pre-polymer layer remaining directly upon/above the CNT film is cured to co-form a given adjacent polymer layer.

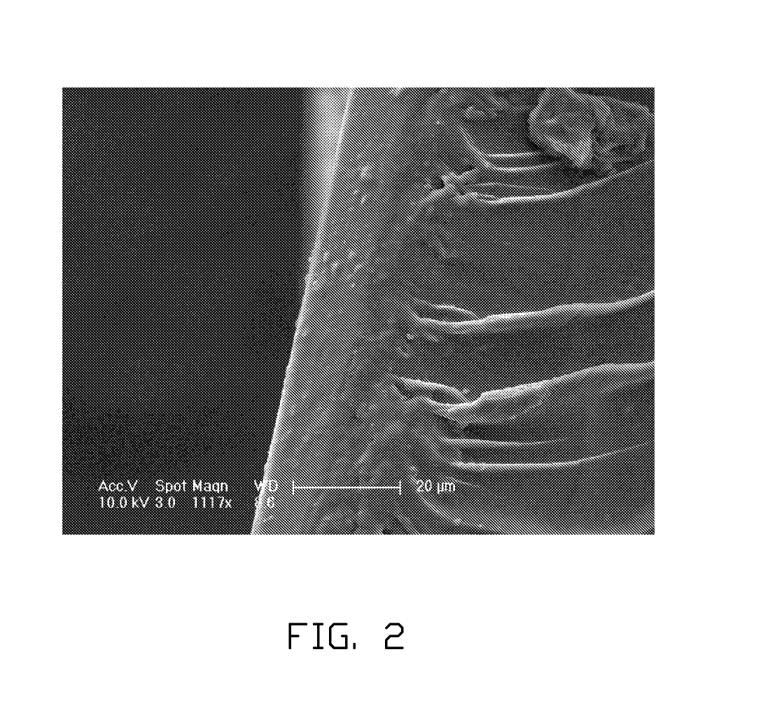

As shown in FIG. 2, the thickness of the CNT/polymer layer 12 is about 10 μm.

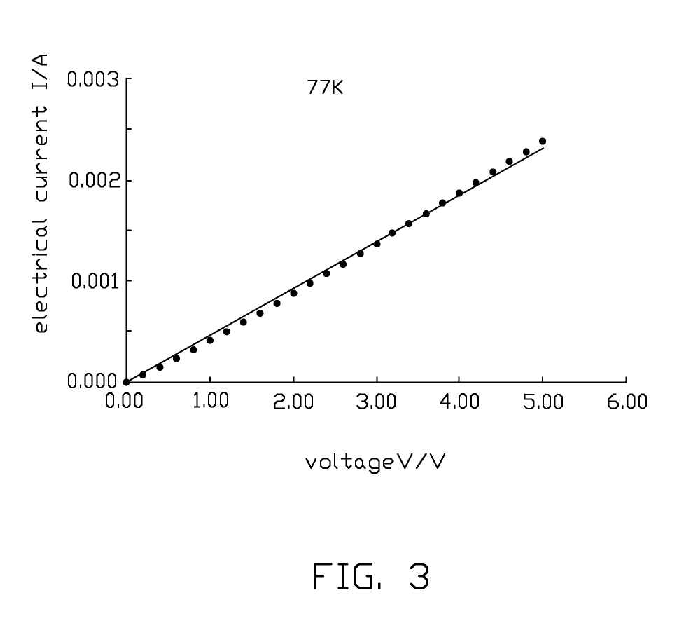

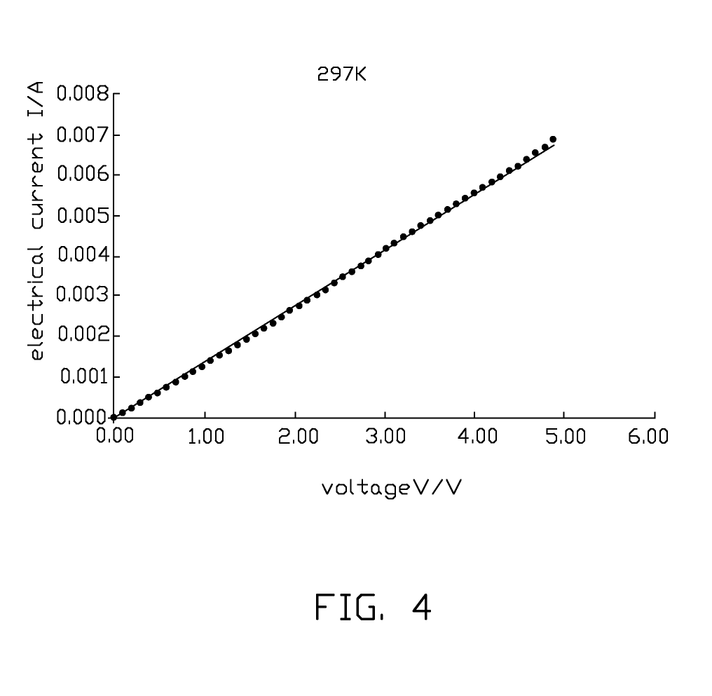

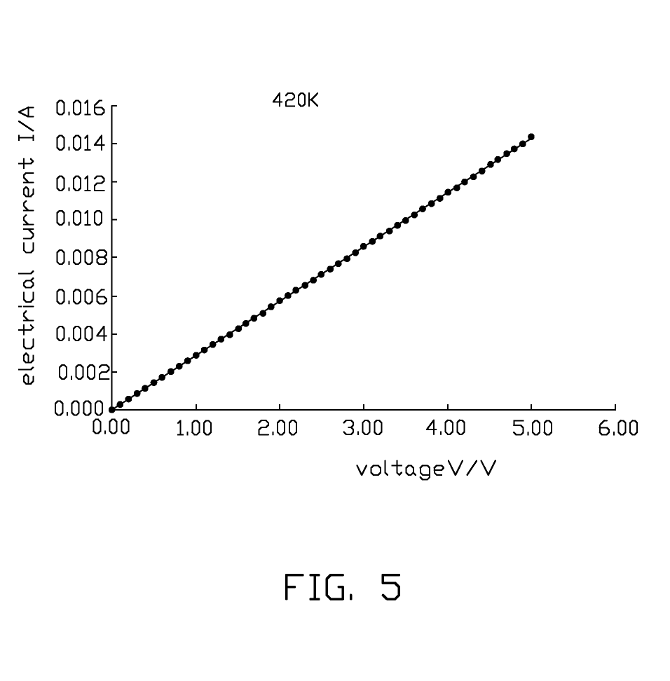

Referring to FIGS. 3 through 5, the current-voltage of the CNT/polymer composite 10 along the lateral direction is linear. A slope of the current-voltage graph is small, namely, a resistance parallel to the top surface 16 is low at each of a low temperature of 77 K, a room temperature of 297 K, and a high temperature of 420 K. Consequently, an electrical conductivity of the CNT/polymer composite 10 along the lateral direction and a thermal stability thereof are improved.

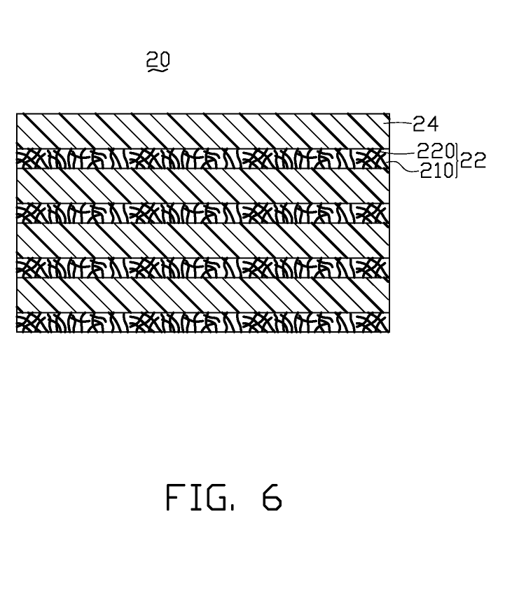

Referring to FIG. 6, a CNT/polymer composite 20, according to another present embodiment, includes a number of CNT/polymer layers 22 and a number of polymer material layers 24. Each CNT/polymer layer 22 includes a polymer material 210 and a number of CNTs 220 embedded therein. The CNT/polymer layers 22 and the polymer material layers 24 are provided in a staggered/alternating arrangement (i.e., no two layers of the same type arranged adjacent one another) and are combined into one piece (i.e., adjacent layers thereof being bonded together). Accordingly, except the top and bottom layer, each CNT/polymer layer 22 is sandwiched between two adjacent polymer material layers 24, and each polymer material layer 24 is sandwiched between two adjacent CNT/polymer layers 22.

CNTs 220 are dispersed in the CNT/polymer layer 210 uniformly and orderly, and each CNT 220 contacts with the adjacent ones. Thus, a number of electrically and/or thermally conductive paths in the CNT/polymer composite 20 are formed. The structure of the CNT/polymer composite 20 is similar to that of the CNT/polymer composite 10, except that the CNT/polymer composite 20 includes a number of layers.

The method for manufacturing the CNT/polymer composite 20 is similar to that of the CNT/polymer composite 10.

The electrical conductivity of the CNT/polymer composite along the lateral orientation is 120 S/m (siemens per meter), two orders of magnitude higher than that of the conventional CNT/polymer composite. Furthermore, the thermal conductivity of the CNT/polymer composite is also higher than that of the conventional CNT/polymer composite.

The thickness and other dimension of the CNT/polymer composite can be chosen by the designers, based on the use requirements. For example, the CNT/polymer composite including one CNT/polymer layer and one polymer material layer can, beneficially, be used as a high-powered capacitor, and the CNT/polymer composite including more than one CNT/polymer layers and more than one polymer material layers can be used, advantageously, as an electromagnetic shielding component or, potentially, as a multi-layer capacitor.

The CNT/polymer composite can be formed in a desired pattern, according to the application requirements, and can, e.g., be in a film form that makes them portable and integral. Then, the CNT/polymer composite can, e.g., be applied in any large-scaled ICs and furthermore in any large-scaled electronic components. Additional uses of the CNT/polymer composite beyond the electronics area (e.g., thermal transfer devices) are readily conceivable and are considered to be within the scope of the present composite material.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A carbon nanotube/polymer composite, comprising at least one polymer material layer and at least one carbon nanotube/polymer layer, the carbon nanotube/polymer layer comprising a polymer material and a plurality of carbon nanotubes embedded in the polymer material, the carbon nanotube/polymer layer comprising a top surface and a bottom surface opposite to the top surface, at least one of the top surface and bottom surface contacting an adjacent polymer material layer, the carbon nanotubes respectively contacting at least one respective adjacent carbon nanotube to thereby yield a network of contacting carbon nanotubes.

2. The carbon nanotube/polymer composite as claimed in claim 1, wherein the polymer material is comprised of at least one material selected from the group consisting of polymethyl methacrylate, polyethyl acrylate, polybutyl acrylate, polystyrene, polybutadiene, and polyacrylonitrile.

3. The carbon nanotube/polymer composite as claimed in claim 1, wherein the carbon nanotubes are dispersed in the carbon nanotube/polymer layer uniformly.

4. The carbon nanotube/polymer composite as claimed in claim 1, wherein the carbon nanotubes of the carbon nanotube/polymer layer extend out of at least one of the top surface and the bottom surface of the carbon nanotube/polymer layer.

5. The carbon nanotube/polymer composite as claimed in claim 1, wherein the carbon nanotube/polymer composite includes a plurality of polymer material layers and a plurality of carbon nanotube/polymer layers, the polymer material layers and the carbon nanotube/polymer layers being alternately arranged.

6. The carbon nanotube/polymer composite as claimed in claim 1, wherein a thickness of the polymer material layer is in the approximate range from 0.02 millimeters to 2 millimeters.

7. The carbon nanotube/polymer composite as claimed in claim 1, wherein a thickness of the carbon nanotube/polymer layer is in the approximate range from 1 micron to 100 microns.

8. The carbon nanotube/polymer composite as claimed in claim 1, wherein the carbon nanotubes are at least one of single-wall nanotubes and multi-wall nanotubes.

9. The carbon nanotube/polymer composite as claimed in claim 1, wherein a length of the carbon nanotubes is in the approximate range from 1 micron to 1000 microns.
